(19) United States
(12) Patent Application Publication
(10) Pub. No.: US 2016/0092147 A1
(43) Pub. Date: Mar. 31, 2016

(54) PRINTING SYSTEM, PRINTING APPARATUS, AND CONTROL METHOD FOR THE PRINTING SYSTEM

(71) Applicant: CANON KABUSHIKI KAISHA, Tokyo (JP)

(72) Inventor: Sho Nakamura, Tokyo (JP)

(21) Appl. No.: 14/863,113

(22) Filed: Sep. 23, 2015

(30) Foreign Application Priority Data
Sep. 25, 2014 (JP) 2014-195817

(51) Int. Cl. G06F 3/12; G06K 15/10; G06K 15/02

(52) U.S. Cl. CPC G06F 3/1251; G06K 15/022; G06K 15/102; G06K 15/1809; G06F 3/1219; G06F 3/1215

(57) ABSTRACT

A printing system includes a first printing unit including a first image processing unit that generates image data from print data, a second printing unit including a second image processing unit that generates image data from print data, and a generation unit that generates skip data for setting a skip area where the first printing unit does not perform printing on a continuous sheet, on the basis of the image data to be printed by the second printing unit, in which the first printing unit prints an image based on the image data in an area other than the skip area of the continuous sheet on the basis of the generated skip data, and the second printing unit prints an image based on the image data in the skip area of the continuous sheet or an area corresponding to the skip area on the basis of the generated skip data.

### BACKGROUND OF THE INVENTION

1. Field of the Invention

The present invention relates to a printing system in which a plurality of printing apparatuses are connected to each other, a printing apparatus, and a control method for the printing system.

2. Description of the Related Art

A printing system constituted by a plurality of printing apparatuses connected to each other in series has been proposed in which printing can be sequentially performed on a continuous recording medium such as a rolled sheet by the respective printing apparatuses. In a printing system constituted by two printing apparatuses, in the case of duplex printing, printing is performed on a front surface by a first printing apparatus, and thereafter, printing is performed on a rear surface by a second printing apparatus. In the case of one-side printing, printing is performed by only one of the first printing apparatus and the second printing apparatus in general. According to the above-described printing system, since the plurality of printing apparatuses are connected to each other in a cascade manner, a conveyance path for the continuous sheet tends to be elongated. For this reason, if a printing operation is stopped because of any factor during the printing operation, it takes time to perform some of printing preparation operations such as winding of the continuous sheet on the elongated conveyance path, pullout of the continuous sheet at the time of printing resumption, and registration adjustment, and printing productivity of the printing system is decreased. As one of the factors for the stop of the printing, a case where image processing for generating image data from print data does not catch up printing speed of the printing apparatus is exemplified. A data buffer is provided between a processing unit configured to perform image processing and a printing unit configured to perform print processing, and the image data generated by the processing unit is stored in the data buffer, and the printing unit sequentially prints the image data in the buffer. At this time, if the image processing does not catch up the printing speed, the data to be printed in the buffer runs out, and the printing operation is stopped.

In view of the above, according to Japanese Patent No. 04650357, a method of inserting a predetermined number of skip pages between the images when it is determined that the generation of the image data does not come in time for the printing timing has been proposed. Accordingly, until the generation of the image data is completed, the printing is skipped, and the sheet is conveyed as a blank sheet without stopping the printing apparatus.

However, according to Japanese Patent No. 04650357, no image is printed in an area of the skip page, and this area of the skip page is discarded. Therefore, each time the generation of the image data does not come in time for the printing timing, the amount of discarded waste is increased, and at the same time, the productivity is also decreased.

### SUMMARY OF THE INVENTION

To address the above-described problems, a printing system according to an aspect of the present invention includes: a first printing unit including a first image processing unit configured to generate image data from print data; a second printing unit including a second image processing unit configured to generate image data from print data; and a generation unit configured to generate skip data for setting a skip area where the first printing unit does not perform printing on a continuous sheet, on the basis of the image data to be printed by the second printing unit, in which the first printing unit prints an image based on the image data in an area other than the skip area of the continuous sheet on the basis of the skip data generated by the generation unit, and the second printing unit prints an image based on the image data in the skip area of the continuous sheet or an area corresponding to the skip area on the basis of the skip data generated by the generation unit.

Further features of the present invention will become apparent from the following description of exemplary embodiments with reference to the attached drawings.

### BRIEF DESCRIPTION OF THE DRAWINGS

FIG. 1 illustrates a configuration of an image printing system according to an exemplary embodiment of the present invention.

FIG. 2 is a block diagram for describing a configuration of a controller in a print control system according to an exemplary embodiment of the present invention.

FIG. 3 is a block diagram for describing a configuration of an engine in the print control system according to an exemplary embodiment of the present invention.

FIG. 4 is a flow chart when data sorting is performed in a first printing apparatus according to an exemplary embodiment of the present invention.

FIG. 5 illustrates a pattern to be printed on a first surface according to an exemplary embodiment of the present invention.

FIG. 6 illustrates a pattern to be printed on a second surface according to an exemplary embodiment of the present invention.

FIG. 7 is a flow chart when printing is performed in the first printing apparatus according to an exemplary embodiment of the present invention.

FIG. 8 is a flow chart when printing is performed in a second printing apparatus according to an exemplary embodiment of the present invention.

FIG. 9 illustrates a pattern to be printed when duplex printing is performed according to an exemplary embodiment of the present invention.

FIGS. 10A and 10B are flow charts when the duplex printing is performed according to an exemplary embodiment of the present invention.

FIG. 11 is a flow chart when the first printing apparatus determines whether or not a control pattern is printed by a second printing apparatus according to an exemplary embodiment of the present invention.

FIG. 12 is a flow chart for inquiring the second printing apparatus and determining whether or not the control pattern is to be printed by the second printing apparatus according to an exemplary embodiment of the present invention.

### DESCRIPTION OF THE EMBODIMENTS

### First Exemplary Embodiment

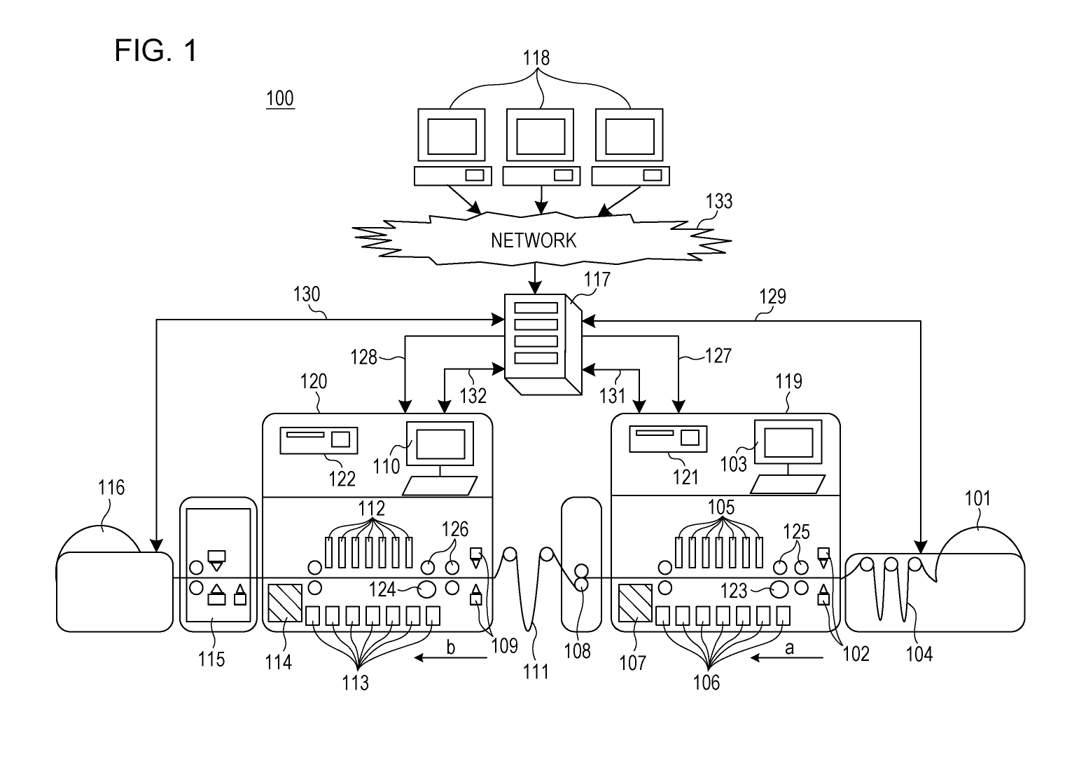

FIG. 1 illustrates a schematic configuration of a cascade printing system (hereinafter, will also be referred to as printing system) according to an exemplary embodiment of the present exemplary embodiment.

A configuration in which a roll sheet is used as a medium to be recorded on which print processing is performed will be described as an example. However, the configuration is not limited to the rolled medium as long as the medium is a lengthy continuous sheet on which printing of a plurality of pages can be continuously performed on a same surface without cutting in mid-course.

In a case where an operation of the print processing in the printing apparatus is controlled by an instruction from an external apparatus connected separately from the printing system in FIG. 1, this external apparatus functions as the print control apparatus.

FIG. 1 is a cross sectional view illustrating an outline of an entire configuration of the printing system in which the roll sheet (continuous sheet longer than a length of the unit of printing (one page) in a conveyance direction) is used as the medium to be recorded. The printing system includes the following constituent elements 101 to 133, and these constituent elements are arranged in a plurality of casings. A printing system 100 includes a first printing apparatus 119 located on an upstream side in the conveyance direction of the continuous sheet and a second printing apparatus 120 located on a downstream side in the conveyance direction. The printing system 100 also includes a controller 117 and a host computer 118. The first printing apparatus 119, the second printing apparatus 120, and the host computer 118 described above are connected to the controller 117. The printing system 100 further includes a sheet feeding unit 101 configured to supply a continuous sheet to the first printing apparatus 119, a sheet reversing unit 108 provided between the first printing apparatus 119 and the second printing apparatus 120, a scanner unit 115, and a winding unit 116.

The sheet feeding unit 101 supplies a rolled sheet corresponding to a continuous sheet (hereinafter, will be referred to as sheet) to the first printing apparatus 119, and the winding unit 116 winds the sheet on which the printing has been completed. The sheet reversing unit 108 performs face reversing of the sheet that is output from the first printing apparatus 119. The scanner unit 115 picks up an image after the printing completion and performs checking. The controller 117 performs a control on the first printing apparatus 119 and the second printing apparatus 120.

The host computer 118 transmits a print job to the controller 117 via a network 133. The host computer 118 performs setting such as a selection of an image to be printed, a print size, and a layout and creates a print job. In FIG. 1, a host computer connected to the network 133 is illustrated as the host computer 118, but the configuration is not limited to this. A host computer directly connected to the controller 117 may also be adopted. In addition, the controller 117 obtains the print job from the host computer 118, but the configuration is not limited to this. For example, the print job may also be obtained from portable media such as a USB memory. The host computer 118 obtains a progress state of the transmitted print job from the controller 117, the first printing apparatus 119, and the second printing apparatus 120 and performs a management. The controller 117 receives the print job (print data) from the host computer 118 and transmits the print data to the first printing apparatus 119 and the second printing apparatus 120 via data communication interfaces (IFs) 127 and 128. The data communication IFs 127 and 128 are constituted by interfaces that can perform high-speed data transmission and reception such as optical fiber and can transmit a large volume of print data from the controller 117 to the first printing apparatus 119 and the second printing apparatus 120.

The controller 117 also transmits control commands to the first printing apparatus 119, the second printing apparatus 120, the sheet feeding unit 101, and the winding unit 116 via control communication IFs 129, 130, 131, and 132 and perform controls of the respective apparatuses. The controller 117 also transmits information of the print job and various pieces of setting data used for the printing and the control to the first printing apparatus 119 and the second printing apparatus 120 via the control communication IFs 131 and 132. The controller 117 also obtains states of the respective printing apparatuses and information indicating that the print job is being printed, the printing has been completed, or the like from the first printing apparatus 119 and the second printing apparatus 120.

According to the present exemplary embodiment, the first printing apparatus 119 receives the print job (print data) for a first surface from the controller 117 via data communication interface (hereinafter, will be referred to as IF) 127. Thereafter, a control unit 121 configured to govern various controls for the entirety of the first printing apparatus 119 performs image processing and obtains image data from the print data. The first printing apparatus 119 is provided with a mark reading sensor 102 configured to read a mark printed on the sheet, a printing head 105, an ink tank 106 from which ink is supplied to the printing head 105, and a drying unit 107 configured to dry the ink of the image printed on the sheet. An operation unit 103 is a unit used by the user to perform various operations and used to notify the user of various pieces of information. For example, the user can check a printing state for each order as to whether the print job is being printed, the printing has been completed, or the like. In addition, the user can check various states of the apparatus such as an ink remaining amount and a sheet remaining amount, input an adjusted value of a recording head position and a registration adjustment value, and instruct an execution of an apparatus maintenance such as a recovery operation of the recording head. The first printing apparatus 119 includes the control unit 121, an encoder 123 configured to control a conveyance amount and a conveyance state of the medium to be recorded, and a conveyance roller 125. The control unit 121 has a built-in control unit provided with a controller (including a CPU or an MPU), an output device of user interface information (generator of display information, audio information, or the like), and various I/O interfaces. The first printing apparatus 119 controls the entirety of the first printing apparatus 119 in an overall manner. The configuration of the first printing apparatus 119 is not limited to this, and a unit or a sensor, for example, may be added as necessary.

The print job (print data) for the first surface or a second surface is transferred to the second printing apparatus 120 from the controller 117 via the data communication IF 128. Thereafter, the control unit 122 configured to govern various controls for the entirety of the second printing apparatus 120 performs image processing and obtains image data from the print data. The second printing apparatus 120 is provided with a reading apparatus 109 such as a sensor or a scanner configured to read a mark printed on the sheet, a printing head 112, and an ink tank 113 from which ink is supplied to the printing head 112. The second printing apparatus 120 is also provided with a drying unit 114 configured to dry the ink of the image printed on the sheet and an operation unit 110. The operation unit 110 is a unit used by the user to perform various operations and used to notify the user of various pieces of information. The second printing apparatus 120 includes the control unit 122, an encoder 124 configured to control a conveyance amount and a conveyance state of the medium to be recorded, and a conveyance roller 126. The control unit 122 has a built-in control unit provided with a controller (including a CPU or an MPU), an output device (generator of display information, audio information, or the like) of user interface information, and various I/O interfaces. The control unit 122 controls the entirety of the second printing apparatus 120 in an overall manner. With regard to the configuration of the second printing apparatus 120, the configuration of the configuration of is not limited to this. For example, a unit, a sensor, or the like may be added as necessary.

In addition, according to the present exemplary embodiment, the first printing apparatus 119 and the second printing apparatus 120 have the same configuration. However, a different configuration may be adopted in which a control circuit board for performing a control of the sheet feeding unit 101 is mounted only on the first printing apparatus 119, and the configuration is not limited to the configuration of the present exemplary embodiment.

The sheet feeding unit 101 performs a control for conveying the sheet to the first printing apparatus 119. The user mounts the sheet on a control bar in the unit to be thereafter loaded into the main body of the sheet feeding unit 101. The sheet feeding unit 101 accepts an instruction of starting of the sheet feeding from the controller 117 via a command transmission and reception IF of the control communication IF 129 and starts the sheet conveyance. A loop creation control unit 104 that absorbs an error of the conveyance speed performs an adjustment of the conveyance speed of the sheet. Although the loop control is provided in the sheet feeding unit 101, a loop control unit that absorbs the conveyance speed may be provided in the first printing apparatus 119. The sheet pulled out from the sheet feeding unit 101 is conveyed in an “a” direction in the drawing to reach the first printing apparatus 119. According to the present exemplary embodiment, a configuration of the roll sheet is illustrated as the sheet feeding unit 101, but feeding of a continuous sheet that does not have a rolled shape may also be performed.

The first printing apparatus 119 performs the image printing on the first surface in accordance with the print data received from the controller 117. In the printing head 105, independent heads for a plurality of colors (seven colors according to the present exemplary embodiment) are held in the sheet conveyance direction. According to the present exemplary embodiment, seven line-type printing heads corresponding to seven colors including C (cyan), M (magenta), Y (yellow), LC (light cyan), LM (light magenta), G (gray), and K (black) are provided. Of course, printing heads using colors other than these colors may be used, and all of these colors may not necessarily be used. The first printing apparatus 119 forms the image on the sheet by causing the printing head 105 to eject the ink in synchronism with the sheet conveyance. It is noted that the printing head 105 is arranged at a position that is not overlapped with the conveyance roller 125. Instead of the configuration in which the ink is directly ejected onto the sheet, the ink may be applied to an intermediate transfer member, and thereafter, this ink may be applied to the sheet to form the image.

The ink tank 106 independently stores the ink of the respective colors. The ink is supplied from the ink tank 106 to sub tanks provided so as to correspond to the respective colors by tubes, and the ink is supplied from the sub tanks to the respective printing heads 105 via the tubes. In the printing head 105, the line heads of the respective colors (seven colors according to the present exemplary embodiment) are aligned in the “a” direction corresponding to the conveyance direction at the time of the printing. The line heads of the respective colors may be formed of a single nozzle tip without joints, or divided nozzle tips may be aligned in line or regularly arranged like a zigzag alignment. According to the present exemplary embodiment, a so-called full multi-head in which the nozzles are aligned in a range that covers a width of a printable area of a sheet at a maximum size that can be used by the present apparatus is adopted.

After the image is formed on the sheet, this sheet is conveyed to the drying unit 107. After drying of the image printed on the sheet is completed, this sheet is conveyed to the sheet reversing unit 108. In the sheet reversing unit 108, when the duplex printing is performed in the present printing system, the side of the sheet is reversed to perform printing on a rear surface of the image on the first surface that has been printed by the first printing apparatus 119. The reversed sheet on which the first surface has been printed goes through a loop creation control unit 111 that absorbs an error of the conveyance speed after passing through the drying unit and reaches the second printing apparatus 120. Although the loop control is provided behind the sheet reversing unit 108, a loop control unit that absorbs the conveyance speed may be provided in the second printing apparatus 120. It is noted that the sheet reversing unit 108 can be detachably attached. In a case where the one-side printing is performed as in a flow that will be described below, it is possible to adopt a configuration in which the sheet reversing unit 108 is detached, and the printing is performed on the first surface by both the first printing apparatus 119 and the second printing apparatus 120.

The second printing apparatus 120 performs image printing on the second surface in accordance with the print data received from the first printing apparatus 119. First, a mark reading sensor 109 reads a mark printed on the first surface for position detection or image recognition indicating which kind of image is printed on the first surface and performs confirmation of the image on the second surface corresponding to the first surface and decision on a print starting position of the image on the second surface. The print image on the second surface and a printing timing are measured in accordance with the result read by the mark reading sensor 102. In the printing head 112, similarly as in the printing head 105, independent heads for a plurality of colors (seven colors according to the present exemplary embodiment) are held in the sheet conveyance direction. Since the configuration of the printing head 112 is similar to that of the printing head 105, descriptions thereof will be omitted. The second printing apparatus 120 forms the image on the sheet by causing the printing head 112 to eject the ink in synchronism with the sheet conveyance. It is noted that the printing head 112 is arranged at a position that is not overlapped with the conveyance roller 126.

Instead of the configuration in which the ink is directly ejected onto the sheet, the ink may be applied to an intermediate transfer member, and thereafter, this ink may be applied to the sheet to form the image. The ink tank 113 independently stores the ink of the respective colors. The ink is supplied from the ink tank 113 to sub tanks provided so as to correspond to the respective colors by tubes, and the ink is supplied from the sub tanks to the respective printing heads 112 via the tubes. In the printing head 112, line heads of the respective colors (seven colors according to the present exemplary embodiment) are aligned in a “b” direction corresponding to the conveyance direction at the time of the printing. The line heads of the respective colors may be formed of a single nozzle tip without joints, or divided nozzle tips may be aligned in line or regularly arranged like a zigzag alignment. According to the present exemplary embodiment, a so-called full multi-head in which the nozzles are aligned in the range that covers the width of the printable area of the sheet at the maximum size that can be used by the present apparatus is adopted.

After the image is formed on the sheet, this sheet is conveyed to the drying unit 114. After the drying of the image printed on the sheet is completed, this sheet is conveyed to the scanner unit 115.

In the scanner unit 115, two lines of scanner sensors are arranged so as to face each other, and it is possible to read both the surfaces of the sheet at the same time. The images printed on both the surfaces of the sheet are read and checked at the same time. Checking as to whether the printed images have problems by optically reading the images printed on the sheet and a special pattern, checking on a state of the present apparatus including an ejection state of the ink, and the like are performed. According to the present exemplary embodiment, with the image checking method, the ejection state of the ink may be checked by reading a pattern for checking a state of the head, or success and failure of the printing may be checked through a comparison with the original image. The checking method may be appropriately selected from among various methods.

After the completion of the scanning, the sheet is conveyed to the winding unit 116. The winding unit 116 starts a winding operation in response to a winding instruction from the controller 117 via the control communication IF 130 and performs winding of the sheet on which both the surfaces have been printed.

In the first printing apparatus 119 and the second printing apparatus 120, a system using heating elements, a system using piezoelectric elements, a system using electrostatic elements, a system using MEMS elements, or the like can be adopted as an ink jet system in which the ink is ejected from the respective nozzles. The ink is ejected from the nozzles of the respective heads on the basis of the image data, but the ejection timings are respectively decided by output signals of the encoder 123 and the encoder 124 for the conveyance.

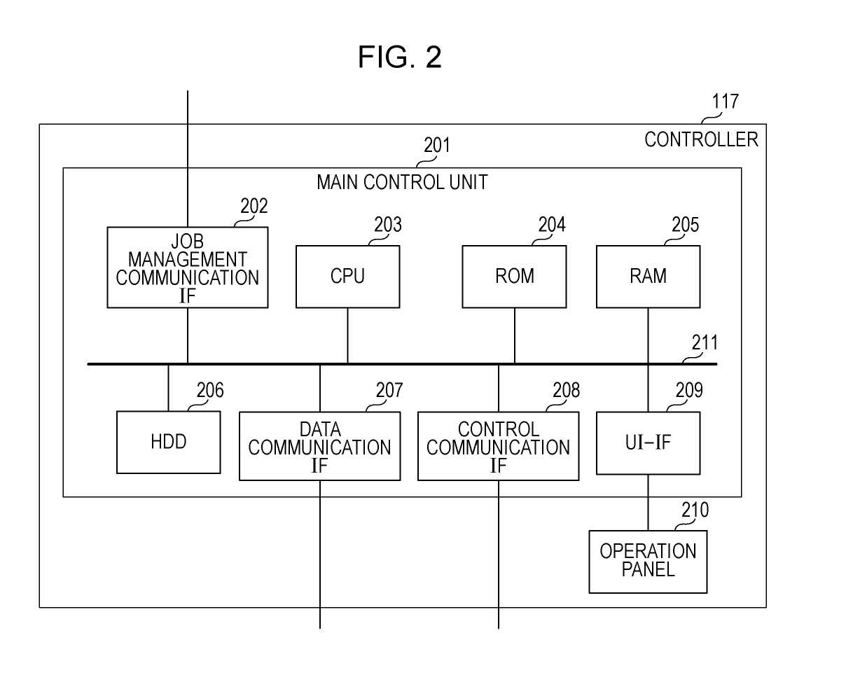

FIG. 2 is a block diagram for describing a configuration of a control in the controller 117 applied according to the present exemplary embodiment. In FIG. 2, the controller 117 is constituted by a main control unit 201 and an operation panel 210. These constituent elements are connected to each other by a system bus 211.

The main control unit 201 functions as a main control unit of the controller 117. The main control unit 201 transmits the print job supplied from the host computer 118 to the first printing apparatus 119. Furthermore, the main control unit 201 performs a print control of the first printing apparatus 119 and the second printing apparatus 120 which are connected to the main control unit 201 via a control communication IF 208 and a data communication IF 207. The main control unit 201 includes a job management communication IF 202, a CPU 203, a ROM 204, a RAM 205, an HDD 206, the data communication IF 207, the control communication IF 208, and a UI-IF 209. These constituent elements are connected to one another by the system bus 211.

The job management communication IF 202 is an interface where the print job supplied from the host computer 118, the other commands, and furthermore, status signals, and the like are transmitted and received.

The CPU 203 performs various computations to control the entirety of the controller 117 in a centralized manner. The ROM 204 includes various control programs executed by the CPU 203 and fixed data. The RAM 205 is a work area used when the CPU 203 performs the various computations and controls. The HDD 206 is an area where the print job supplied from the host computer 118, a necessary table, and the like are temporarily stored.

The data communication IF 207 is an interface where the print data stored in the HDD 206 is transmitted to the first printing apparatus 119 and the second printing apparatus 120.

The control communication IF 208 is an interface where control commands, status signals, and the like are transmitted and received to and from the first printing apparatus 119 and the second printing apparatus 120.

The UI-IF 209 is an interface where the commands and the like are transmitted and received to and from the operation panel 210.

The operation panel 210 is an input apparatus used by the user to perform the operation of the first printing apparatus 119 and the second printing apparatus 120, the print setting, and the like. Furthermore, the operation panel 210 is a display apparatus configured to notify the user of statuses and the like of the first printing apparatus 119 and the second printing apparatus 120. The operation panel 210 is connected to the system bus 211 via the UI-IF 209 of the main control unit 201.

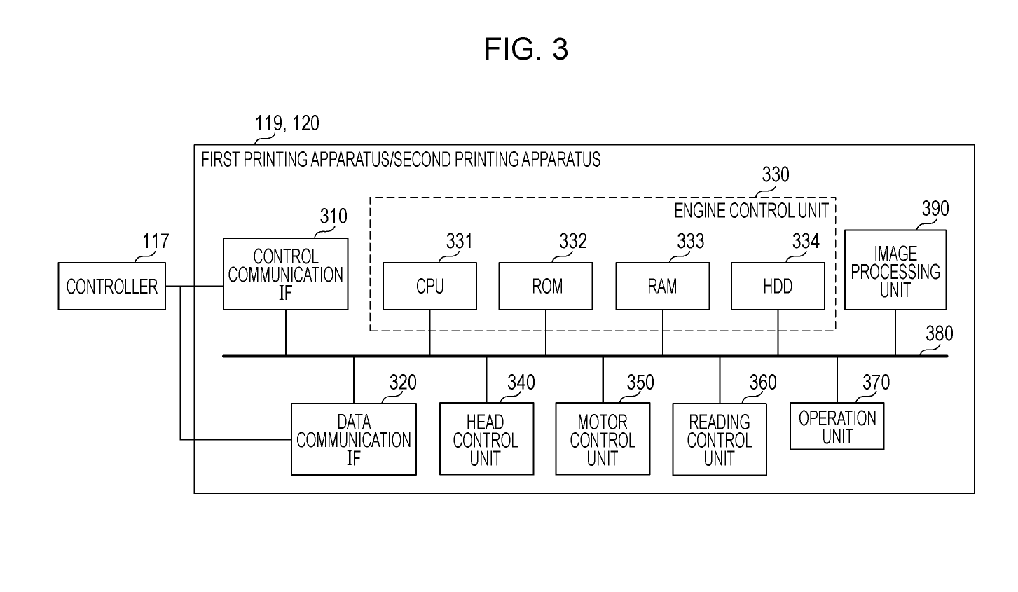

FIG. 3 is a block diagram illustrating a control configuration of the first printing apparatus 119 and the second printing apparatus 120. It is noted that, according to the present exemplary embodiment, the descriptions will be given while the first printing apparatus 119 and the second printing apparatus 120 have the same configuration, but different configurations may be adopted. Herein, the descriptions will be given by using the first printing apparatus 119 as an example.

The first printing apparatus 119 includes a control communication IF 310, a data communication IF 320, an engine control unit 330, a head control unit 340, a motor control unit 350, a reading control unit 360, an operation unit 370, and an image processing unit 390. These constituent elements are connected to one another by a system bus 380.

The engine control unit 330, the head control unit 340, the motor control unit 350, the reading control unit 360, and the image processing unit 390 which are illustrated in FIG. 3 are mainly included in the control unit 121. It is noted that these constituent elements are included in the control unit 122 in the second printing apparatus 120.

In addition, the operation unit 370 corresponds to the operation unit 103. In the second printing apparatus 120, the operation unit 370 corresponds to the operation unit 110.

The control communication IF 310 and the data communication IF 320 are interfaces for connecting the first printing apparatus 119 to the controller 117. The control communication IF 310 is an interface for receiving the control commands, the status signals, and the like from the controller 117. The data communication IF 320 is an interface for receiving the print job from the controller 117.

The engine control unit 330 is constituted by a CPU 331, a ROM 332, a RAM 333, and an HDD 334, and these constituent elements are connected to one another by the system bus 380. The CPU 331 performs various computations and controls the entirety of the first printing apparatus 119 and the second printing apparatus 120. The ROM 332 stores various control programs executed by the CPU 331 and fixed data used for various operations of the printing apparatus. The RAM 333 is used as a work area for the CPU 331 or used as a temporary storage area for various pieces of received data, or stores various pieces of setting data. The HDD 334 stores parameters used for the various operations of the printing apparatus, a necessary table, and the like. Although the detail will be described below, according to the present exemplary embodiment, the CPU 331 of the first printing apparatus 119 transmits the print data to the second printing apparatus 120 as necessary in the case of the one-side printing.

The engine control unit 330 performs control of the head control unit 340, the motor control unit 350, and the reading control unit 360 in accordance with the control commands received from the controller 117 via the control communication IF 310 and records the image based on the image data on the recording medium. The image processing unit 390 includes a CPU, a ROM, and a RAM similarly as in the engine control unit 330. In the image processing unit 390, a color space is converted from a color space (for example, YCbCr) of the received print job to a standard RGB color space (for example, sRGB). In addition, various image processings such as resolution conversion into an effective pixel number, image analysis, and image correction are performed as necessary. The image data obtained by these image processings is stored in the HDD 334.

The head control unit 340 performs the drive control of the printing head 105 in accordance with the control command received from the engine control unit 330 via the system bus 380 and the image data on which the image processing has been applied in the image processing unit 390. Accordingly, the image based on the image data is recorded on the recording medium.

The motor control unit 350 performs the control of the conveyance mechanism such as the drive control of the conveyance rollers 125 and 126 in accordance with the control command received from the engine control unit 330 via the system bus 380.

The reading control unit 360 performs the detection of the mark and the like printed on the recording medium by using the mark reading sensors 102 and 109 in accordance with the control command received from the engine control unit 330 via the system bus 380.

The operation unit 370 is an input/output IF with respect to the user and includes an input unit such as a hard key and a touch panel and an output unit such as a display and an audio generator configured to present information to the user. The operation unit 370 performs the parameter setting used for the various operations of the printing apparatus, the display of the printing state and the used sheet, and the like.

It is noted that, according to the present exemplary embodiment, the descriptions have been given while the control of the head control unit 340, the motor control unit 350, and the reading control unit 360 is performed in accordance with the control command received by the engine control unit 330 from the controller 117, but the configuration is not limited to this. The control commands may be transmitted and received between the respective control units, and the control commands may be directly received by the respective control units from the controller 117.

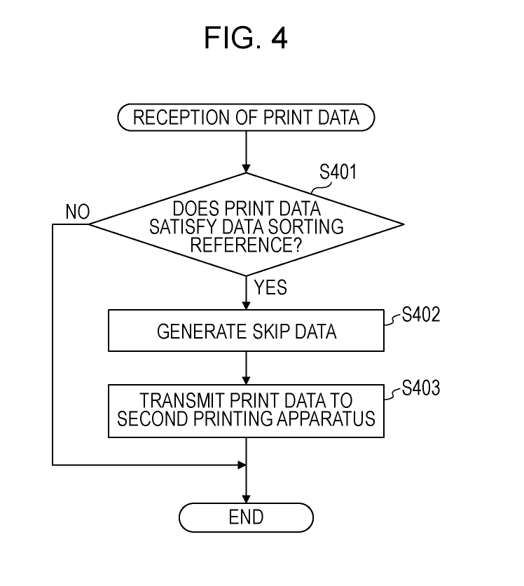

FIG. 4 is a flow chart when the first printing apparatus 119 located on an upstream side of the printing system receives the one-side print job (one-side print data) and transmits the print job that satisfies a data sorting reference (criterion) to the second printing apparatus 120 located on a downstream side of the printing system. The processing illustrated in FIG. 4 is realized while the CPU 331 of the first printing apparatus 119 reads out the program stored in the ROM 332 onto the RAM 333 to be executed.

When the first printing apparatus 119 receives the one-side print data, a determination is made as to whether or not the job satisfies the data sorting reference in step S401. According to the present exemplary embodiment, whether or not the image processing takes time is used for the determination of the data sorting reference. A method of determining whether or not the image processing takes time is not particularly limited, and the determination may be made on the basis of a length of the image. Specifically, for example, a width is obtained from the image size information in the print data, and the determination is made as to whether or not the image processing takes time depending on a condition if the image size width of the print data exceeds a predetermined value. This is because, if the data includes an image having a long width in the conveyance direction, it is expected that the image processing takes much time. In this manner, when only the data in which the image processing takes time is sorted to the second printing apparatus 120, it is possible to alleviate a risk of missing the print timing. It is noted that the determination of the data sorting reference is not limited to this. For example, it is also possible to make the determination depending on whether or not the page number of the print data is an odd number. The data having an odd page number is processed by the first printing apparatus 119, and the data having an even page number is processed by the second printing apparatus 120.

A reason therefor is as follows. For example, among print data A, print data B, and print data C, the print data C is set to have a large image size width, and the image processing on the print data C takes time. In a case where all the three pieces of print data are sequentially processed by the first printing apparatus 119, the print data C is to be processed after the print data B is processed. That is, the image processing on the print data C should be completed during a period after the processing related to the print data B is completed until the print starting position where the image based on the image data of the print data C is to be printed reaches the head position. If the image processing on the print data C is not completed until the print starting position where the image based on the image data of the print data C is to be printed reaches the head position, the printing apparatus should be stopped. In contrast to this, if the print data C is sorted to the second printing apparatus 120 in advance as in the present exemplary embodiment, the second printing apparatus 120 can spend time only for the image processing on the print data C in a period during which the first printing apparatus 119 processes the print data A and the print data B. For this reason, the above-described risk can be alleviated as compared with a case where only the first printing apparatus 119 performs all the image processings. This effect is also similarly attained in a case where the other reference (for example, a case where the determination is made depending on whether the page is an even number or an odd number) is set as the data sorting reference. Herein, the sorting of the print data may be the units of image in one page, the units of page, the units of a plurality of pages, the units of print job, or the like.

It is noted that, according to the present exemplary embodiment, the example in which the determination is made depending on whether or not the length of the image (image size width) exceeds a predetermined value has been described as the reference on whether or not the image processing takes time, but the configuration is not limited to this. The determination as to whether or not the image processing takes time may be made by using the other information. For example, the determination may be made depending on whether or not the number of images that are rotated by an arbitrary rotation angle (for example, 0.1°) is higher than or equal to a predetermined number by referring to image rotation information in the print data. Alternatively, the determination may also be made depending on whether or not a predetermined number or more of plural objects exist in a multilayer structure by referring to object information of a PDF file format. It is noted that the determination may also be made by combining a plurality of above-described methods to each other.

In addition, the method of deciding the above-described reference value is not particularly limited. A window time of the image processing in the first printing apparatus 119 and a window time added when the data is sorted to the second printing apparatus 120 may be previously calculated from the information such as the conveyance speed or the conveyance distance between the two apparatuses, and the reference value may be decided on the basis of these window times.

In step S401, it is determined as to whether or not the print data satisfies the data sorting reference. Sorting to the first printing apparatus 119 and the second printing apparatus 120 is decided on the basis of this determination result. When it is determined that the print data satisfies the data sorting reference (S401: YES), skip data is created by referring to the print data relevant to the above-described reference (step S402). Thereafter, the print data is transmitted to the second printing apparatus 120 (step S403), and the processing is ended.

On the other hand, when it is determined that the data sorting reference is not satisfied (S401: NO), the processing is ended. In this case, all the print data is processed by the first printing apparatus 119.

Herein, the skip data refers to data for providing a blank to a position where the first printing apparatus 119 is expected to print the print data by the second printing apparatus 120. The print job transmitted in step S403 is printed by the second printing apparatus 120 on the downstream side. In a case where the plurality of printing apparatuses perform the one-side printing, in the first printing apparatus 119 on the upstream side in the sheet conveyance, a blank area is previously provided to a position where the printing is expected to be performed by the second printing apparatus 120 on the downstream side. Therefore, a skip starting position mark with which the second printing apparatus 120 can detect a blank starting position such that the printing can be performed in the blank area of the continuous sheet and the blank area including a size of the image included in the print job expected to be printed by the second printing apparatus 120 are prepared by the first printing apparatus 119 as the skip data.

As the method of creating the skip data which is performed in step S402, for example, a method of duplicating the print job transmitted in step S403 and adding control information indicating the skip data to the duplicated print data is exemplified. According to this method, the first printing apparatus 119 determines if this control information is added in a flow of the printing operation which will be described below and can perform the printing of the blank starting position mark and skipping of the size including the image size. According to the present exemplary embodiment, the first printing apparatus 119 executes the data sorting processing, but the controller 117 may execute the data sorting processing instead. That is, the controller 117 may decide whether the processing is performed by the first printing apparatus 119 or the second printing apparatus 120 in accordance with the data sorting reference, and the print data may be transmitted to each of the printing apparatuses.

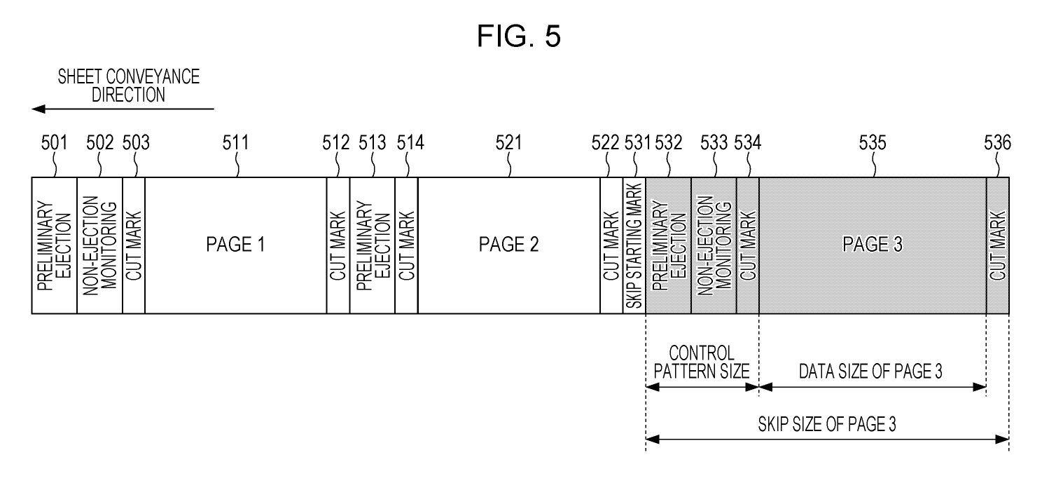

FIG. 5 illustrates an image pattern example in which the skip page is printed on the first surface by the second printing apparatus 120. In the example illustrated in FIG. 5, the sheet reversing unit 108 is detached, and the printing is performed on the same surface of the continuous sheet by the first printing apparatus 119 and the second printing apparatus 120.

A leading end preliminary ejection pattern is a preliminary ejection pattern printed on a leading end of the sheet. The leading end preliminary ejection pattern is, for example, a pattern previously held in the HDD 334 and is a pattern for performing the printing on the sheet leading end. A non-ejection monitoring pattern is a checking pattern for checking whether or not a state of non-ejection occurs in the printing head and is one of the control patterns. With regard to the non-ejection monitoring pattern, for example, a dedicated pattern for each head color is previously held in the HDD 334 and is printed in a case where a print instruction of the non-ejection monitoring pattern is issued. The preliminary ejection pattern is inserted between images at random or at a certain constant interval and is one of the control patterns for maintaining a quality of the image. The preliminary ejection pattern is previously held in the HDD 334 and is printed between images at random or at a certain constant interval. A cut mark is a mark printed such that cutting can be performed in a back-end process. The cut mark is, for example, a mark previously held in the HDD 334. A shape of the mark may be any pattern. The shape may be a circular shape or a triangular shape, and any shape may be adopted as long as the mark can be read in the back-end process. The image processing units 390 of the respective printing apparatuses perform raster image processing (RIP) with respect to the print data received from the controller 117, and a normal image is printed on the basis of the image data on which the RIP has been performed. That is, the normal image is an image based on the image data generated from the print data.

FIG. 5 exemplifies a case where an image on a first page and an image on a second page are printed by the first printing apparatus 119, and an image on a third page is printed by the second printing apparatus 120.

As illustrated in FIG. 5, after a leading end preliminary ejection pattern 501, a non-ejection monitoring pattern 502, and a cut mark 503 are printed, a normal image 511 is printed. After a cut mark 512 accompanied by the normal image 511 is printed, a preliminary ejection pattern 513 is printed, and a cut mark 514 is printed to cut the preliminary ejection pattern 513 in the back-end process. Thereafter, a normal image 521 on the second page is printed, and a cut mark 522 accompanied by the normal image 521 is printed. Subsequently, a skip starting mark 531 of an area skipped by the first printing apparatus 119 is printed. In this manner, the leading end preliminary ejection pattern 501 to the skip starting mark 531 are printed by the first printing apparatus 119. The skip starting mark is not particularly limited as long as the starting position of the skip can be recognized. For example, an identification mark such as a barcode is exemplified as the skip starting mark.

Next, the second printing apparatus 120 reads the skip starting mark 531 by the mark reading sensor 109 of the second printing apparatus to find a starting point of the skip area. Thereafter, the preliminary ejection pattern 532 and the non-ejection monitoring pattern 533 are printed in the skip area, and the cut mark 534 is printed so that these control patterns (the preliminary ejection pattern 532 and the non-ejection monitoring pattern 533) can be cut in the back-end process. Thereafter, a normal image 535 on the third page is printed, and a cut mark 536 accompanied by the normal image 535 is printed.

It is noted that the normal image 511 and the normal image 521 are the images based on the image data obtained by performing the image processing on the print data received from the controller 117 by the image processing unit 390 of the first printing apparatus 119. The normal image 535 is the image based on the image data obtained by performing the image processing on the print data received from the controller 117 by the image processing unit 390 of the second printing apparatus 120.

As illustrated in FIG. 5, a size by which the first printing apparatus 119 skips (hereinafter, will be referred to as skip size) is a size obtained by adding the size of the control pattern to the size of the image. That is, the first printing apparatus 119 generates the data for skipping the blank areas for the control patterns and the image and the skip starting position mark as the skip data.

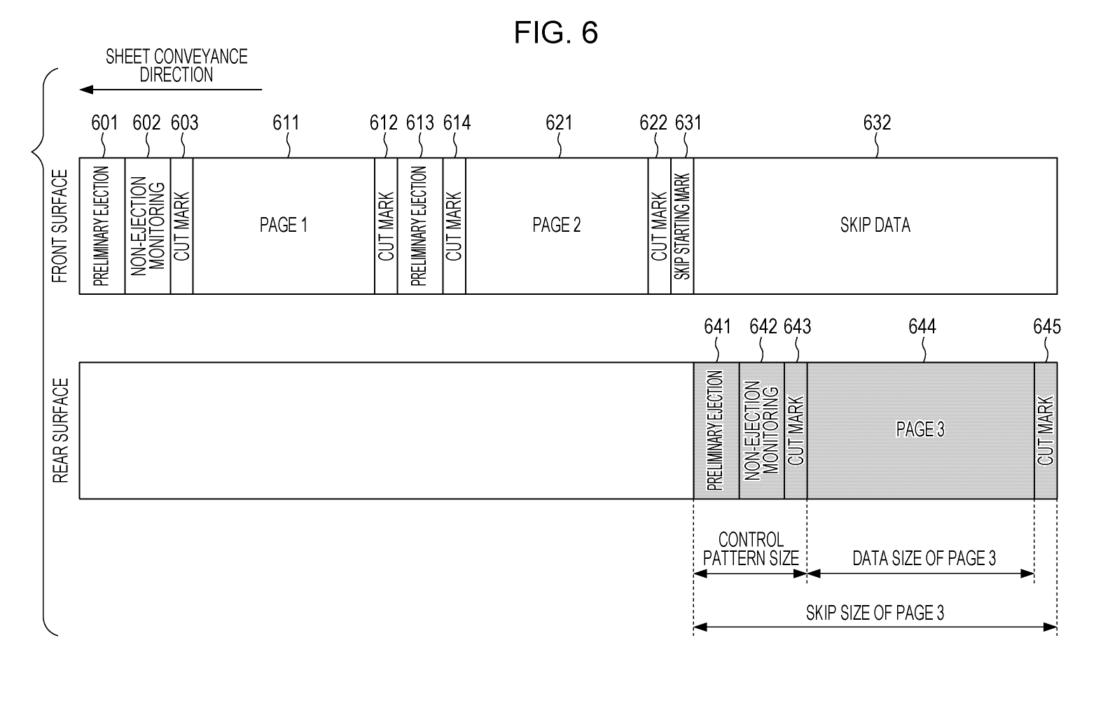

FIG. 6 illustrates an image pattern example in which the skip page is printed on the second surface by the second printing apparatus 120. In the example illustrated in FIG. 6, the sheet reversing unit 108 is used as it is without being detached, and the printing is performed on the different surfaces of the continuous sheet by the first printing apparatus 119 and the second printing apparatus 120. Since the leading end preliminary ejection pattern, the non-ejection monitoring pattern, the preliminary ejection pattern, and the cut mark are similar to those of FIG. 5, descriptions thereof will be omitted.

As illustrated in FIG. 6, after a leading end preliminary ejection pattern 601, a non-ejection monitoring pattern 602, and a cut mark 603 are printed, a normal image 611 is printed. After a cut mark 612 accompanied by the normal image 611 is printed, a preliminary ejection pattern 613 is printed, and a cut mark 614 is printed to cut the preliminary ejection pattern 613 in the back-end process. Thereafter, a normal image 621 on the second page is printed, and a cut mark 622 accompanied by the normal image 621 is printed. Subsequently, a skip starting mark 631 of an area skipped by the first printing apparatus 119 is printed. In this manner, the preliminary ejection pattern 601 to the skip starting mark 631 are printed by the first printing apparatus 119.

Subsequently, the continuous sheet is reversed by the sheet reversing unit 108, and thereafter, the mark reading sensor 109 of the second printing apparatus 120 is read by the skip starting mark 631 to find a starting point of the skip area. A preliminary ejection pattern 641 and a non-ejection monitoring pattern 642 are printed in the skip area, and a cut mark 634 is printed so that these control patterns (the preliminary ejection pattern 641 and the non-ejection monitoring pattern 642) can be cut in the back-end process. Thereafter, a normal image 644 on the third page is printed, and a cut mark 645 accompanied by the normal image 644 is printed.

It is noted that the normal image 611 and the normal image 621 are the images based on the image data obtained by performing the image processing on the print data received from the controller 117 by the image processing unit 390 of the first printing apparatus 119. The normal image 644 is the image based on the image data obtained by performing the image processing on the print data received from the first printing apparatus 119 by the image processing unit 390 of the second printing apparatus 120.

As illustrated in FIG. 6, a size by which the first printing apparatus 119 skips (hereinafter, will be referred to as skip size) is a size obtained by adding the size of the control pattern to the size of the image similarly as in the case of FIG. 5. That is, the first printing apparatus 119 generates the data for skipping the blank areas for the control patterns and the image and the skip starting position mark as the skip data.

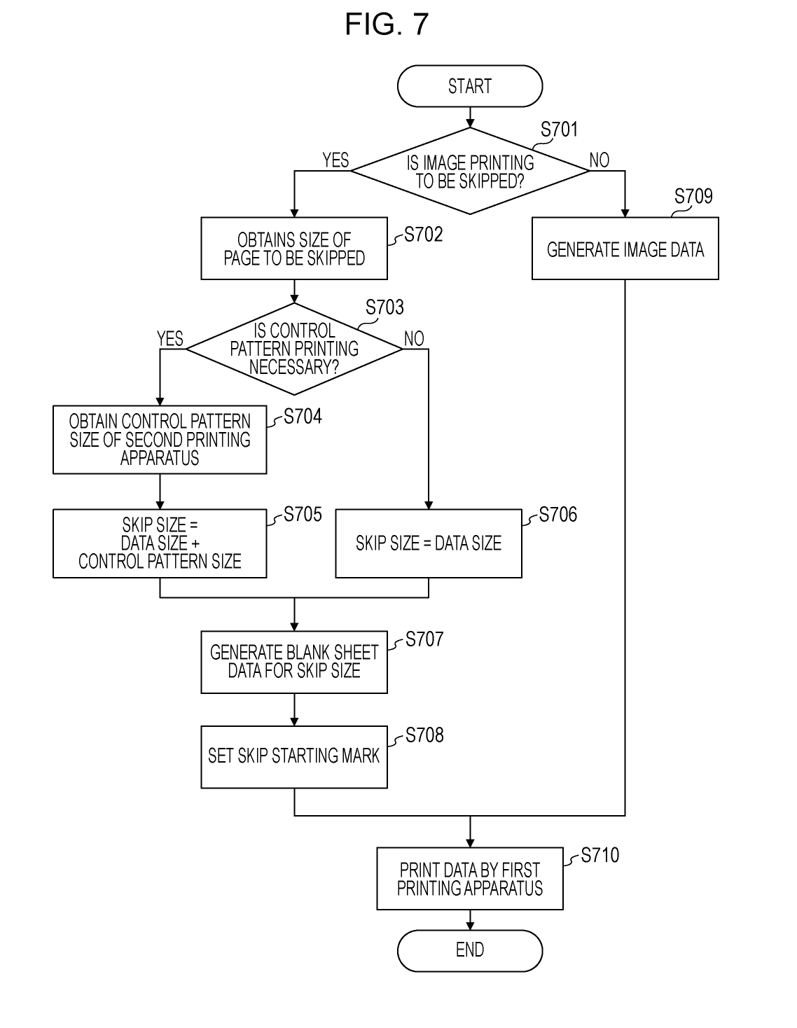

FIG. 7 is a flow chart when the printing is performed by the first printing apparatus 119. The processing illustrated in FIG. 7 is realized while the CPU 331 of the first printing apparatus 119 reads out the program stored in the ROM 332 onto the RAM 333 to be executed.

In S701, a determination is made as to whether or not the printing of the page image is skipped. That is, a determination is made as to whether or not this image is an image to be printed by the first printing apparatus 119. When it is determined that the printing is skipped, that is, it is determined that this image is not the image to be printed by the first printing apparatus 119 (S701: YES), the flow proceeds to S702. When it is determined that the printing is not skipped, that is, it is determined that this image is the image to be printed by the first printing apparatus 119 (S701: NO), the flow proceeds to S709.

In S709, image data of the page image is generated. That is, the image processing is applied on the print data received from the controller 117 to generate the image data in an image processing unit 309.

In S702, a print data size of the page image to be skipped is obtained. The print data size may be obtained from the controller 117 or calculated from the print setting by the first printing apparatus 119.

Next, in S703, a determination is made as to whether or not the printing of the control pattern is necessary in the second printing apparatus 120. Information used for the determination as to whether or not the printing of the control pattern is necessary may be obtained from the second printing apparatus 120 via the controller 117 or predicted by the first printing apparatus 119. When it is determined that the printing of the control pattern is necessary (S703: YES), the flow proceeds to S704. When it is determined that the printing of the control pattern is unnecessary (S703: NO), the flow proceeds to S706.

In S706, a skip size is decided by the first printing apparatus 119. This skip size is the size of the page image in S702.

In S704, a size of the control pattern printed by the second printing apparatus 120 is obtained. The size of the control pattern may be obtained from the second printing apparatus 120 via the controller 117 or calculated by the first printing apparatus 119.

In S705, the first printing apparatus 119 decides a skip size. This skip size is obtained by adding the size of the page image in S702 to the size of the control pattern obtained in S704.

In S707, blank sheet data for the skip sizes decided in S705 or S706 is generated, and a skip starting mark is set in S708. In this manner, according to the present exemplary embodiment, the skip size may be a size of the image based on the image data or a total size of the size of the image based on the image data and the size of the control pattern. It is noted that S402 corresponds to S702 to S708. That is, S702 and S703 correspond to steps for generating the skip data in S402.

Subsequently, in S710, the image based on the image data is printed. Herein, the skip starting mark set in S708 is printed, or the image based on the image data generated in S709 is printed. It is noted that the image is not printed in the area of the blank sheet data on the basis of the blank sheet data generated in S707. In a case where the image data is generated in S709, the control pattern is also printed as necessary.

Accordingly, the print processing of the one page image is ended. This processing is repeatedly performed until the processing for all the page images is completed. As a result, the first printing apparatus 119 generates the skip data and also prints the image based on the image data in an area other than the skip area.

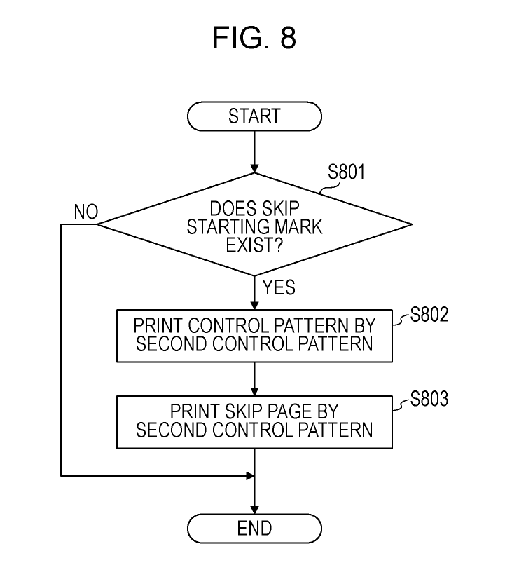

FIG. 8 is a flow chart when the second printing apparatus 120 performs the printing. The processing illustrated in FIG. 8 is realized while the CPU 331 of the second printing apparatus 120 reads out the program stored in the ROM 332 onto the RAM 333 to be executed.

In S801, the skip starting mark is read by the mark reading sensor. In a case where the skip starting mark is not read, the second printing apparatus 120 does not perform the printing. In a case where the skip starting mark is found, the control pattern is printed in S802. It is noted that, in a case where the printing of the control pattern is unnecessary, the control pattern is not printed, and the flow proceeds to 803.

Next, in S803, the page image skipped by the first printing apparatus 119 is printed. Specifically, the second printing apparatus 120 generates image data by applying the image processing on the print data received from the first printing apparatus 119 in the image processing unit 309 and prints the page image on the basis of the image data. That is, the image based on the image data generated in the image processing unit 309 is printed in the area that is skipped by the first printing apparatus 119 and corresponds to the blank area after the control pattern printed in S802.

Accordingly, the print processing of the one page image is ended. This processing is repeatedly performed until the processing for all the page images is completed.

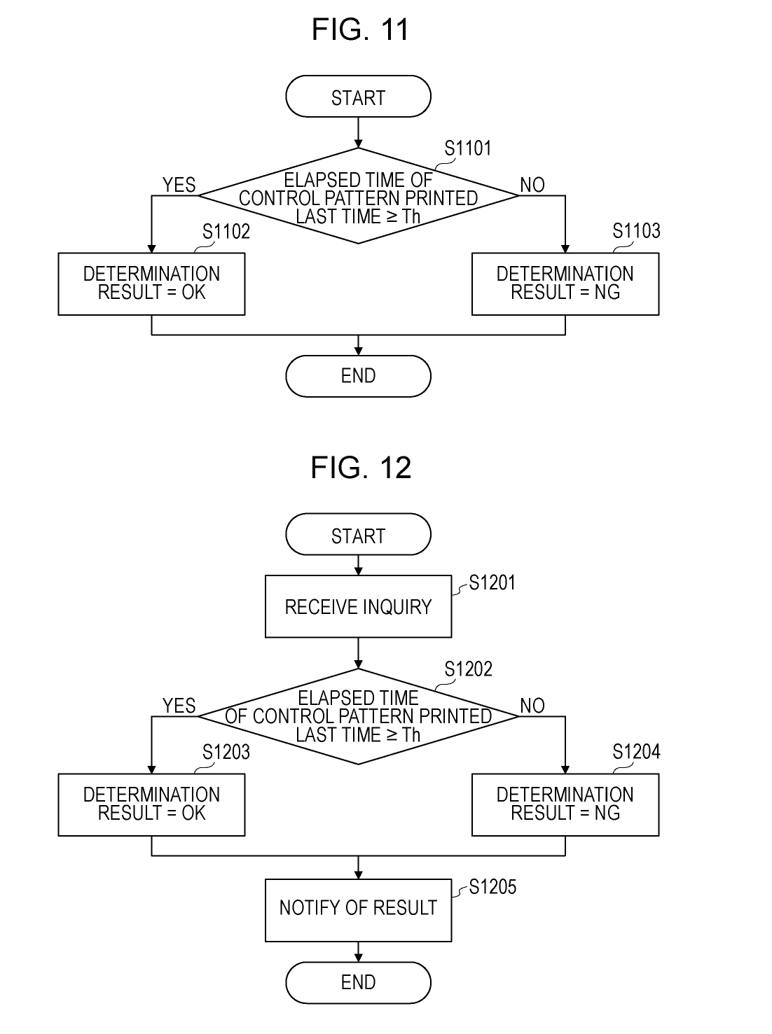

FIG. 11 is a detailed flow chart of the determination as to whether or not the control pattern printing in S703 of FIG. 7 is necessary. The processing illustrated in FIG. 11 is realized while the CPU 331 of the first printing apparatus 119 reads out the program stored in the ROM 332 onto the RAM 333 to be executed. That is, in FIG. 11, the first printing apparatus 119 determines whether or not the control pattern is necessary in the second printing apparatus 120.

In S1101, an elapsed time since the control pattern is printed last time is longer than or equal to a previously determined threshold Th. Herein, the second printing apparatus 120 is in a state in which the printed is not yet executed, and therefore, the elapsed time since the lastly inserted control pattern is printed is projected on the basis of the length of the image or the like. Th is a time that defines an interval for printing the control pattern. When it is determined that the elapsed time is longer than or equal to Th (S1101: YES), the flow proceeds to S1102, and a determination result is set as OK. That is, it is determined that the printing of the control pattern is necessary. In a case where the elapsed time is shorter than Th (S1101: NO), the flow proceeds to S1103, and the determination result is set as NG. That is, it is determined that the printing of the control pattern is unnecessary.

It is noted that, according to the present exemplary embodiment, the elapsed time is used for the determination as to whether or not the control pattern is to be printed, but the configuration is not limited to this. For example, an ejection amount of ink is used. In a case where an ejection amount of a certain head reaches an ejection amount higher than or equal to a threshold, the determination may be made that the printing of the control pattern is necessary.

FIG. 12 is a detailed flow chart of a determination unit as to whether or not the control pattern printing in S703 of FIG. 7 is necessary. The processing illustrated in FIG. 12 is realized while the CPU 331 of the second printing apparatus 120 reads out the program stored in the ROM 332 onto the RAM 333 to be executed.

In FIG. 12, the second printing apparatus 120 determines whether or not the control pattern is necessary in the second printing apparatus 120, and the first printing apparatus 119 is notified of the determination result.

In S1201, the second printing apparatus 120 receives an inquiry on whether or not the printing of the control pattern is necessary. It is noted that, after the first printing apparatus 119 of FIG. 1 inquires the controller 117, the controller 117 may inquire the second printing apparatus 120. Alternatively, the controller 117 may previously inquire the second printing apparatus 120 when the skip data is transmitted to the first printing apparatus 119.

In S1202, the elapsed time since the control pattern is printed last time is longer than or equal to a previously determined threshold Th. Herein, the second printing apparatus 120 is in a state in which the printed is not yet executed, and therefore, the elapsed time since the lastly inserted control pattern is printed is projected on the basis of the length of the image or the like. Th is a time that defines an interval for printing the control pattern. When it is determined that the elapsed time is longer than or equal to Th (S1202: YES), the flow proceeds to S1203, and the determination result is set as OK. That is, it is determined that the printing of the control pattern is necessary. In a case where the elapsed time is shorter than Th (S1202: NO), the flow proceeds to S1204, and the determination result is set as NG. That is, it is determined that the printing of the control pattern is unnecessary. It is noted that, according to the present exemplary embodiment, the elapsed time is used for the determination as to whether or not the control pattern is to be printed. However, an ejection amount of ink is used, and in a case where an ejection amount of a certain head reaches an ejection amount higher than or equal to a threshold, the determination may be made that the printing of the control pattern is necessary.

In S1205, the controller 117 is notified of the determination result. It is noted that the first printing apparatus 119 is notified of the determination result via the controller 117.

According to the present exemplary embodiment, while the stop of the printing operation is suppressed, the discarded waste of the continuous sheet can be reduced. That is, while the one-side printing is performed by using the two printing apparatus, the state in which the printing is stopped when the image processing misses the timing. Specifically, on the basis of a predetermined reference such as a case where the printing misses the timing, the one-side print data is sorted to the two printing apparatuses, and the printing based on the one-side print data is executed on the one continuous sheet by the two printing apparatuses. At this time, the area of the skip page where the first printing apparatus does not perform the printing is set by taking into account not only the printable area for the image based on the image data but also the printable area for the control pattern. Accordingly, in the printing apparatus of the ink jet system in which the control pattern for the quality management need to be printed at a predetermined timing during the printing, while the quality management is performed, it is possible to execute the printing on the one continuous sheet by the two printing apparatuses. In the printing apparatus of the ink jet system, if the print data is sorted to the plurality of printing apparatuses, the area where the control pattern is to be printed disappears, and the image is not printed on the skipped area. According to the present exemplary embodiment, instead of skipping the printing on the continuous sheet until the printing becomes ready in time (the printing is not performed), the skip data is generated, and the skip area having a size appropriate for the second printing apparatus 120 to execute the printing is provided. Specifically, the printable area for the control pattern and the printable area for the image based on the image data are set as the blank area (skip area) to skip the printing by the first printing apparatus 119, and also, the skip starting mark is printed so that the second printing apparatus 120 can recognize a skip starting area. Accordingly, in the one-side printing, the discarded waste of the continuous sheet can be reduced, and the productivity is improved. In addition, it is possible to suppress the state in which the printing by the first printing apparatus 119 is stopped.

The size of the print data printed by the second printing apparatus 120 may differ in units of page in some cases. For this reason, the timing at which the control pattern is printed by the second printing apparatus 120 may be different from that of the first printing apparatus 119. According to the present exemplary embodiment, in S703, it is determined as to whether or not the printing of the control pattern by the second printing apparatus 120 is necessary, so that the size of the skip data can be appropriately set.

It is noted that a case where the normal duplex printing is performed by the first printing apparatus 119 and the second printing apparatus 120 will be simply described.

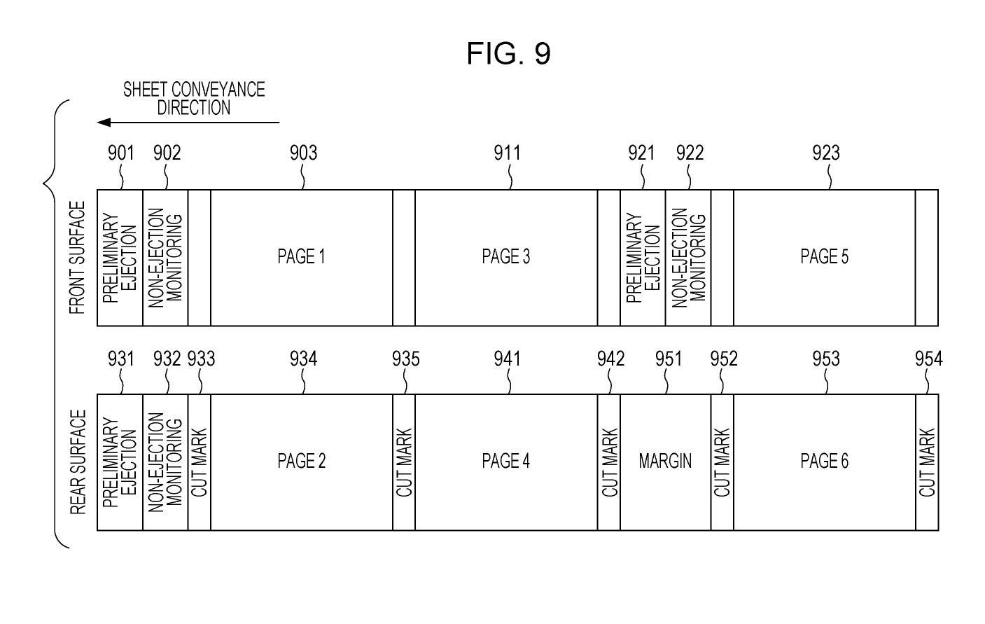

FIG. 9 illustrates an image pattern example printed when the duplex printing is performed. Since the leading end preliminary ejection pattern, the non-ejection monitoring pattern, the preliminary ejection pattern, and the cut mark are similar to those of FIG. 5, descriptions thereof will be omitted.

First, the printing on the front surface of the continuous sheet will be described. A leading end preliminary ejection pattern 901 and a non-ejection monitoring pattern 902 are printed. Subsequently, after a predetermined margin area is provided, the image on the first page is printed as a normal image 903. Thereafter, an area corresponding to the cut mark on the second surface is set as the margin area, and the image on the third page is printed as a normal image 911. Thereafter, the area corresponding to the cut mark on the second surface is set as the margin area, and then a preliminary ejection pattern 921 and a non-ejection monitoring pattern 922 are printed. Thereafter, the area corresponding to the cut mark on the second surface is set as the margin area, the image on the fifth page is printed as a normal image 923.

Next, the printing on the rear surface of the continuous sheet will be described. After a leading end preliminary ejection pattern 931, a non-ejection monitoring pattern 932, and a cut mark 933 are printed, the image on the second page is printed as a normal image 934. After a cut mark 935 accompanied by the normal image 934 is printed, a cut mark 942 is printed. Thereafter, a margin is provided in the area corresponding to the preliminary ejection pattern 921 and the non-ejection monitoring pattern 922 on the front surface. Subsequently, a cut mark 952 for cutting a margin area 951 (the preliminary ejection pattern 921 and the non-ejection monitoring pattern 922) is printed. Subsequently, the image on the sixth page is printed as a normal image 953, and a cut mark 954 accompanied by the normal image 953 is printed.

It is noted that the normal image 903, the normal image 911, and the normal image 923 are the images based on the image data obtained by performing the image processing on the print data received from the controller 117 by the image processing unit 390 of the first printing apparatus 119. The normal image 934, the normal image 941, and the normal image 953 are the images based on the image data obtained by performing the image processing on the print data received from the first printing apparatus 119 by the image processing unit 390 of the second printing apparatus 120.

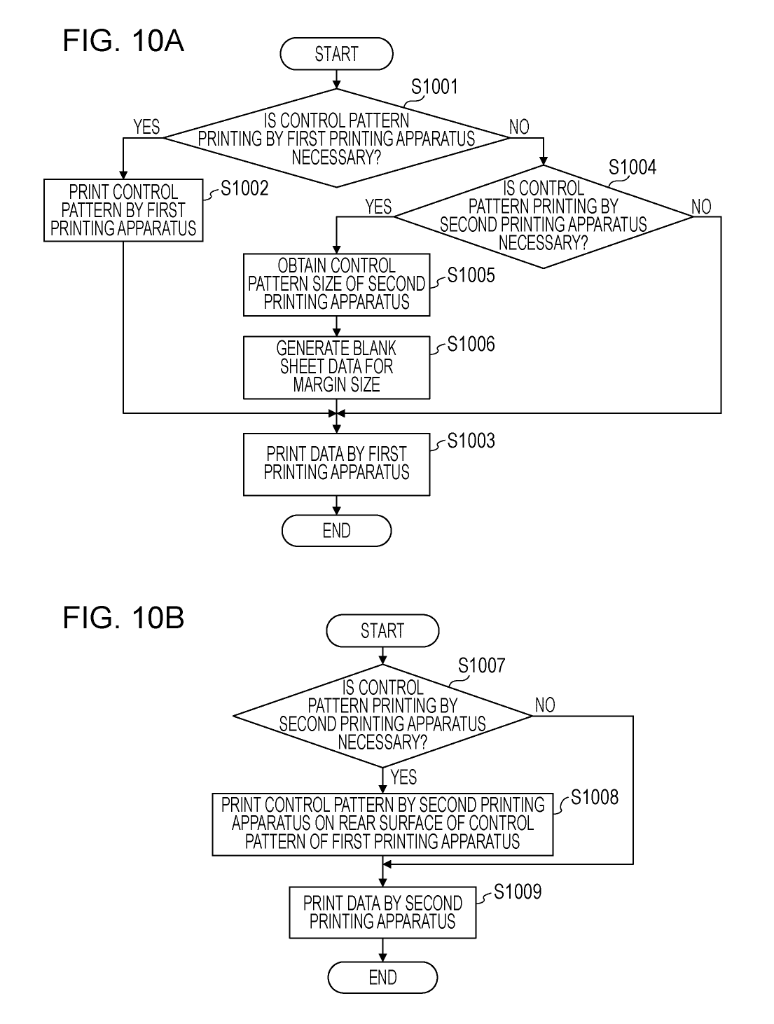

FIGS. 10A and 10B are flow charts when the duplex printing is performed. FIG. 10A is a flow chart of the first printing apparatus 119, and FIG. 10B is a flow chart of the second printing apparatus 120. The processing illustrated in FIG. 10A is realized while the CPU 331 of the first printing apparatus 119 reads out the program stored in the ROM 332 onto the RAM 333 to be executed. The processing illustrated in FIG. 10B is realized while the CPU 331 of the second printing apparatus 120 reads out the program stored in the ROM 332 onto the RAM 333 to be executed.

First, the printing is performed on the first surface of the continuous sheet by the first printing apparatus 119. In S1001, the first printing apparatus 119 determines whether or not the printing of the control pattern is necessary. In a case where the printing is necessary, the flow proceeds to 1002, and in a case where the printing is unnecessary, the flow proceeds to S1004. In S1002, the first printing apparatus 119 performs the printing of the control pattern, and the flow proceeds to S1003.

In S1004, it is determined as to whether or not the printing of the control pattern by the second printing apparatus 120 is necessary. In a case where the printing is necessary (S1004: YES), the flow proceeds to S1005, and in a case where the printing is unnecessary (S1004: NO), the flow proceeds to S1003.

In S1005, the size of the control pattern of the second printing apparatus 120 is obtained. In S1006, the blank sheet data having a margin size corresponding to the obtained size of the control pattern is generated, and the flow proceeds to S1003. Since the method of obtaining the size of the control pattern of the second printing apparatus 120 has been described above, descriptions thereof will be omitted.

In S1003, the first printing apparatus 119 prints the normal image, that is, the image based on the image data.

Accordingly, the print processing of the one page image is ended. This processing is repeatedly performed until the processing for all the page images is completed.

Next, the printing on the second surface of the continuous sheet is performed by the second printing apparatus 120. In S1007, it is determined as to whether or not the printing of the control pattern by the second printing apparatus 120 is necessary. In a case where the printing is necessary, the flow proceeds to S1008, and in a case where the printing is unnecessary, the flow proceeds to S1009.

In S1008, the second printing apparatus 120 performs the printing of the control pattern in the margin area where the printing is not performed by the first printing apparatus 119, and the flow proceeds to S1009.

In S1009, the second printing apparatus 120 prints the normal image, that is, the image based on the image data.

Accordingly, the print processing of the one page image is ended. This processing is repeatedly performed until the processing for all the page images is completed.

According to the present exemplary embodiment, the sheet waste is suppressed, and the productivity can be improved.

### Other Exemplary Embodiments

The present invention is not limited to the above-described exemplary embodiments. For example, according to the above-described exemplary embodiments, the first printing apparatus 119 generates the skip data. The configuration is not limited to this, and the controller 117 may generate the skip data instead. That is, the controller 117 may execute the flow chart of FIG. 4.

In addition, according to the above-described exemplary embodiments, the printing system constituted by the two printing apparatuses has been described, but the configuration is not limited to this. Such a configuration may be adopted that three or more printing apparatuses may be connected in series, or a plurality of sets of the two printing apparatuses connected in series may be constituted in parallel and controlled by the single controller 117. FIG. 1 illustrates the printing system having only the printing function, but the configuration is not limited to this. A printing system further including a reading apparatus configured to read an image on an original and functioning as a copier, or a printing system further having the other functions and functioning as a multifunction peripheral (MFP) may be adopted. The descriptions have been given while the roll sheet is used as the medium to be recorded where the print processing is performed (medium to be recorded or sheet). However, the configuration is not limited to the rolled medium as long as the medium is a lengthy medium to be recorded on which the printing of a plurality of pages can be continuously performed on the same surface without cutting in mid-course. The medium to be recorded may be automatically cut by the printing apparatus or may be cut while the user issues a manual instruction, or cutting processing may be performed in the back-end process. A material of the medium to be recorded is not limited to paper, and various materials may be used as long as the print processing can be performed. In addition, the printing apparatus may be a printing apparatus that can perform the printing not only on the medium to be recorded but also on cut sheets previously cut into a predetermined size.

Moreover, according to the above-described exemplary embodiments, the printing system using the plurality of printing apparatuses has been described, but the configuration is not limited to this. The exemplary embodiments can also be applied to a printing system provided with a plurality of image processing units and a plurality of printing units in the single printing apparatus.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-195817, filed Sep. 25, 2014, which is hereby incorporated by reference herein in its entirety.

What is claimed is:

1. A printing system comprising:
a first printing unit including a first image processing unit configured to generate image data from print data;
a second printing unit including a second image processing unit configured to generate image data from print data; and
a generation unit configured to generate skip data for setting a skip area where the first printing unit does not perform printing on a continuous sheet, on the basis of the image data to be printed by the second printing unit,
wherein the first printing unit prints an image based on the image data in an area other than the skip area of the continuous sheet on the basis of the skip data generated by the generation unit, and
wherein the second printing unit prints an image based on the image data in the skip area of the continuous sheet or an area corresponding to the skip area on the basis of the skip data generated by the generation unit.

2. The printing system according to claim 1,
wherein the generation unit generates the skip data on the basis of the image data printed by the second printing unit and a control pattern printed by the second printing unit, and
wherein the second printing unit prints the image based on the image data and the control pattern in the skip area of the continuous sheet or the area corresponding to the skip area on the basis of the skip data generated by the generation unit.

3. The printing system according to claim 2, wherein the control pattern includes at least one of a preliminary ejection pattern and a non-ejection monitoring pattern.

4. The printing system according to claim 1,
wherein the first printing unit prints an identification mark for identifying a starting position of the skip area before the skip area on the basis of the skip data, and
wherein the second printing unit further includes a detection unit configured to detect the identification mark and execute the printing in accordance with the identification mark.

5. The printing system according to claim 1, further comprising:
a decision unit configured to decide that at least one of the first printing unit and the second printing unit executes print processing of the print data on the basis of a predetermined reference,
wherein the generation unit generates the skip data on the basis of a determination of the determination unit and the image data printed by the second printing unit.

6. The printing system according to claim 1, further comprising:
a determination unit configured to determine whether printing of a control pattern by the second printing unit is necessary,
wherein the generation unit generates the skip data on the basis of a determination result of the determination unit.

7. The printing system according to claim 1, wherein the print data is one-side print data.

8. The printing system according to claim 1, wherein the first printing unit and the second printing unit execute the printing by way of an ink jet system.

9. The printing system according to claim 1,
wherein the first printing unit is provided in a first printing apparatus, and
wherein the second printing unit is provided in a second printing apparatus that is different from the first printing apparatus.

10. The printing system according to claim 1, wherein the first printing unit and the second printing unit are provided in a single printing apparatus.

11. A printing apparatus comprising:
an image processing unit configured to generate image data from print data;
a generation unit configured to generate skip data for setting a skip area where the printing apparatus does not perform printing on a continuous sheet, on the basis of image data to be printed by another printing apparatus; and
a print control unit configured to cause a printing unit to print an image based on the image data in an area other than the skip area of the continuous sheet on the basis of the skip data generated by the generation unit.

12. The printing apparatus according to claim 11, wherein the generation unit generates the skip data on the basis of the image data printed by the other printing apparatus and a control pattern printed by the other printing apparatus.

13. A control method for a printing system including a first printing unit including a first image processing unit configured to generate image data from print data and a second printing unit including a second image processing unit configured to generate image data from print data, the control method comprising:
generating skip data for setting a skip area where the first printing unit does not perform printing on a continuous sheet, on the basis of the image data to be printed by the second printing unit;
causing the first printing unit to print an image based on the image data in an area other than the skip area of the continuous sheet on the basis of the generated skip data; and
causing the second printing unit to print an image based on the image data in the skip area of the continuous sheet or an area corresponding to the skip area on the basis of the generated skip data.

14. The control method according to claim 13,
wherein the generating includes generating the skip data on the basis of the image data printed by the second printing unit and a control pattern printed by the second printing unit, and
wherein the second printing unit prints the image based on the image data and the control pattern in the skip area of the continuous sheet or the area corresponding to the skip area on the basis of the skip data generated by the generation unit.

15. A non-transitory computer-readable recording medium storing a program for causing a computer to execute a method in a printing apparatus, the method comprising:
generating skip data for setting a skip area where the printing apparatus does not perform printing on a continuous sheet, on the basis of image data to be printed by another printing apparatus; and
causing a printing unit to print an image based on the image data in an area other than the skip area of the continuous sheet on the basis of the generated skip data.
